(19) United States
(12) Patent Application Publication
(10) Pub. No.: US 2002/0126236 A1
(43) Pub. Date: Sep. 12, 2002

(54) Display panel module of low electromagnetic radiation

(75) Inventors: Yoshiaki Hiratsuka, Kawasaki (JP); Hisashi Yoshinaga, Kawasaki (JP); Masanori Yamaguchi, Kawasaki (JP)

Correspondence Address: Patrick G. Burns, Esq., GREER, BURNS & CRAIN, LTD., Suite 2500, 300 South Wacker Drive, Chicago, IL, 60606, US

(73) Assignee: FUJITSU LIMITED

(21) Appl. No.: 09/903,211

(22) Filed: Jul. 11, 2001

(30) Foreign Application Priority Data
Mar. 12, 2001 (JP) 2001-069018

(51) Int. Cl. G02F 1/1333

(52) U.S. Cl. 349/58

(57) ABSTRACT

A display panel module such as a liquid crystal display (LCD) panel module in an electronic apparatus is designed to receive a driving signal of a predetermined frequency. An electrically conductive frame or bezel of the display panel module tends to suffer from the transmission of electromagnetic waves which are related to the wavelength of the driving signal. An electrically conductive member is located behind the display panel and electrically connected to the electrically conductive frame. The electrically conductive member serves to diverge the electromagnetic waves out of the electrically conductive frame. This divergence of the electromagnetic waves serves to suppress the electromagnetic radiation out of the electrically conductive frame.

### BACKGROUND OF THE INVENTION

1. Field of the Invention

The present invention relates to a display panel module including a display panel such as a liquid crystal display (LCD) panel, for example.

2. Description of the Prior Art

In general, a display panel module includes a circuit board for controlling the display of an image on a screen of a display panel assembled therein. The circuit board is designed to receive a driving signal from a CPU (Central Processing Unit), for example, of a computer system and the like. A display controller established on the circuit board controls the performance of individual liquid crystal cells on the basis of the supplied driving signal. The driving signal is synchronized with a predetermined clock signal. When the driving signal of a predetermined frequency is transmitted to the display controller, the circuit board tends to radiate electromagnetic waves.

For example, Japanese Patent Application Laid-open No. 10-153766 proposes a pair of shielding plates interposing the circuit board along with the display controller therebetween so as to suppress the radiation of the electromagnetic waves. However, it has been revealed that such a shielding structure cannot enough suppress the radiation of the electromagnetic waves from the LCD panel module.

### SUMMARY OF THE INVENTION

It is accordingly an object of the present invention to provide a display panel module capable of suppressing the radiation of electromagnetic waves in an efficient manner as compared with the aforementioned conventional shielding structure.

According to a first aspect of the present invention, there is provided a display panel module comprising: a display panel defining a screen on a front surface; an electrically conductive frame enclosing the display panel; and an electrically conductive member located behind the display panel and electrically connected to the electrically conductive frame.

In general, a display panel module such as a liquid crystal display (LCD) panel module in an electronic apparatus is designed to receive a driving signal of a predetermined frequency. An electrically conductive frame of the display panel module tends to suffer from the transmission of electromagnetic waves which are related to the wavelength of the driving signal. The electrically conductive member connected to the electrically conductive frame serves to diverge the electromagnetic waves out of the electrically conductive frame. This divergence of the electromagnetic waves serves to suppress the electromagnetic radiation out of the electrically conductive frame.

The electrically conductive member is expected to cooperate with the electrically conductive frame so as to establish a loop line having a length different from the wavelength of the driving signal supplied to the display panel. The present inventors have found out an unknown fact that a larger quantity of the electromagnetic waves is radiated from the display panel module or LCD panel module, rather than a computer unit or main body enclosing a motherboard and the like, in a notebook personal computer, for example. The inventors have also discovered that an electrically conductive frame or bezel for binding the panel-shaped module components in the LCD panel module functions as a loop antenna. When electromagnetic waves are radiated from a circuit board in the LCD panel module on the basis of a driving signal for controlling the display on the screen of the LCD panel module, the driving signal of a predetermined wavelength tends to cause resonance of the electromagnetic waves with the bezel. The inventors have demonstrated this fact. The resonance is supposed to amplify the electromagnetic radiation out of the LCD panel module. If the length of the loop line is different from the wavelength of the driving signal, establishment of a loop antenna can be avoided in the electrically conductive frame. The electromagnetic radiation can thus be suppressed.

Preferably, the length of the loop line is set smaller than the half of the wavelength of the driving signal. In general, the electromagnetic radiation can be promoted in a loop antenna only if the loop antenna has the length equal to the half of the wavelength of the supplied signal. If the loop line is designed to have the length smaller than the half of the wavelength of the driving signal, the electromagnetic radiation out of the electrically conductive frame can be reduced enough. The loop line of this kind can simply be realized by establishment of electric joints between the electrically conductive member and the electrically conductive frame at positions spaced by intervals smaller than the quarter of the wavelength of the driving signal.

In particular, the length of the loop line is preferably set smaller than the quarter of the wavelength of the driving signal. In general, the electromagnetic radiation can remarkably be promoted in a loop antenna only if the loop antenna has the length equal to the quarter of the wavelength of the supplied signal. If the loop line is designed to have the length smaller than the quarter of the wavelength of the driving signal, the electromagnetic radiation out of the electrically conductive frame can considerably be reduced. The loop line of this kind can simply be realized by establishment of electric joints between the electrically conductive member and the electrically conductive frame at positions spaced by intervals smaller than one eighth of the wavelength of the driving signal.

The electrically conductive member can be incorporated within the display panel module, or can be set in an enclosure of an electronic apparatus designed to receive the display panel module. In the latter case, electric joints should be established between the electrically conductive frame and the electrically conductive member when the display panel module has been assembled into the electronic apparatus.

According to a second aspect of the present invention, there is provided a display panel module comprising: a display panel defining a screen on a front surface; a panel-shaped module component superposed on a rear surface of the display panel; and an electrically insulating frame enclosing the display panel and the panel-shaped module component so as to couple the module component to the display panel.

No electric current or electromagnetic wave is transmitted to the electrically insulating frame inside or outside the display panel module. The electrically insulating frame cannot function as a loop antenna at all. The electromagnetic radiation out of the display panel module can reliably be suppressed.

Any of the aforementioned display panel modules may be utilized in a display apparatus such as a television set, a notebook personal computer, an ATM (Automatic Teller Machine), a POS (Point-of-Sales) system terminal, and any other electronic apparatus. The display panel module may include a liquid crystal display (LCD) panel module, a similar flat display panel module, and the like.

### BRIEF DESCRIPTION OF THE DRAWINGS

The above and other objects, features and advantages of the present invention will become apparent from the following description of the preferred embodiments in conjunction with the accompanying drawings, wherein:

FIG. 1 is a perspective view schematically illustrating the exterior of a notebook personal computer as an example of an electronic apparatus;

FIG. 2 is a phantom view schematically illustrating the connection between a motherboard and a liquid crystal display (LCD) panel module;

FIG. 3 is an exploded view of the LCD panel module according to a first embodiment of the present invention;

FIG. 4 is a partial enlarged perspective view schematically illustrating folded portions integral to a bezel;

FIG. 5 is an enlarged side view of the LCD panel module, including a cross-section in part, for schematically illustrating the concept of a loop line;

FIG. 6 is a graph illustrating the relationship between the frequency of a clock signal and the quantity of electromagnetic waves in the LCD panel module according to the present invention;

FIG. 7 is a graph illustrating the relationship between the frequency of a clock signal and the quantity of electromagnetic waves in an LCD panel module according to a comparative example;

FIG. 8 is a plan view schematically illustrating a meshed wire assembled within the LCD panel module;

FIG. 9 is a partial perspective view schematically illustrating an electrically conductive layer formed at the back of a reflector;

FIG. 10 is an enlarged partial perspective view illustrating folded pieces standing inward in the bezel;

FIG. 11 is an enlarged partial plan view illustrating a recess formed in insulating sheets as well as a circuit board;

FIG. 12 is an enlarged partial cross-sectional view illustrating an LCD panel module according to a second embodiment of the present invention; and

FIG. 13 is an exploded view of an LCD panel module according to a third embodiment of the present invention.

### DESCRIPTION OF THE PREFERRED EMBODIMENT

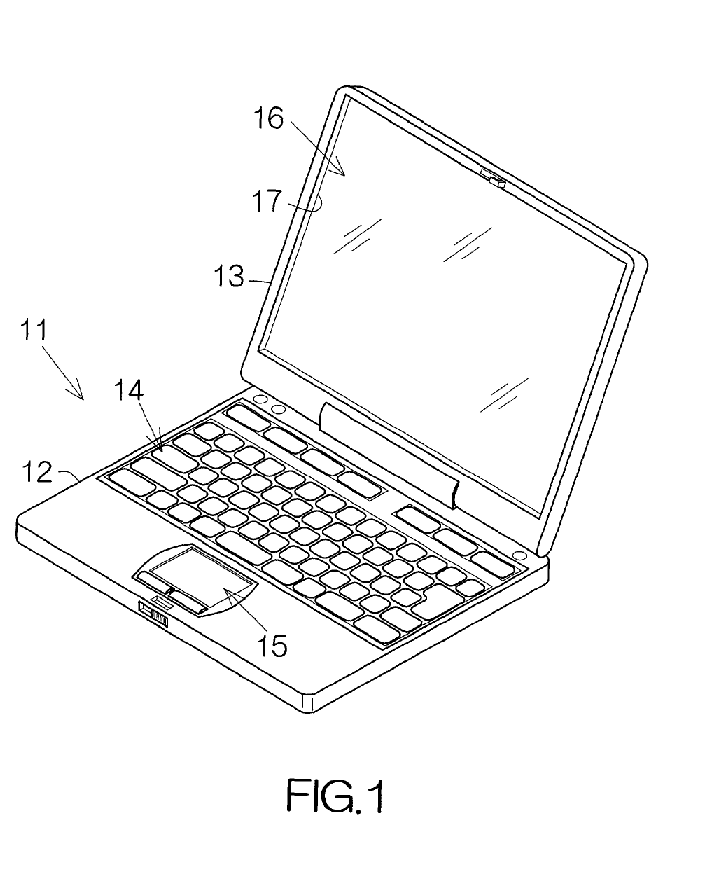

FIG. 1 schematically illustrates the exterior of a notebook personal computer. The notebook personal computer 11 comprises a computer unit or main body 12 of a reduced thickness and a display housing 13 coupled to the main body 12. The display housing 13 is allowed to pivot on the main body 12. Input devices such as a keyboard 14 and a pointing device 15 are embedded in the front or upper surface of the main body 12. A display panel module or liquid crystal display (LCD) panel module 16 is incorporated within the display housing 13. A screen of the LCD panel module 16 is exposed outside through a window 17 defined in the display housing 13. A user or operator is allowed to utilize the keyboard 14 as well as the pointing device 15 so as to manipulate the notebook personal computer 11. Moreover, the user is capable of observing the operation of the notebook personal computer 11 on the basis of text and/or graphics which appear on the screen of the LCD panel module 16, for example. When the display housing 13 is pivoted on the main body 12, the display housing 13 can be superposed on the upper surface of the main body 12 in a well-known manner.

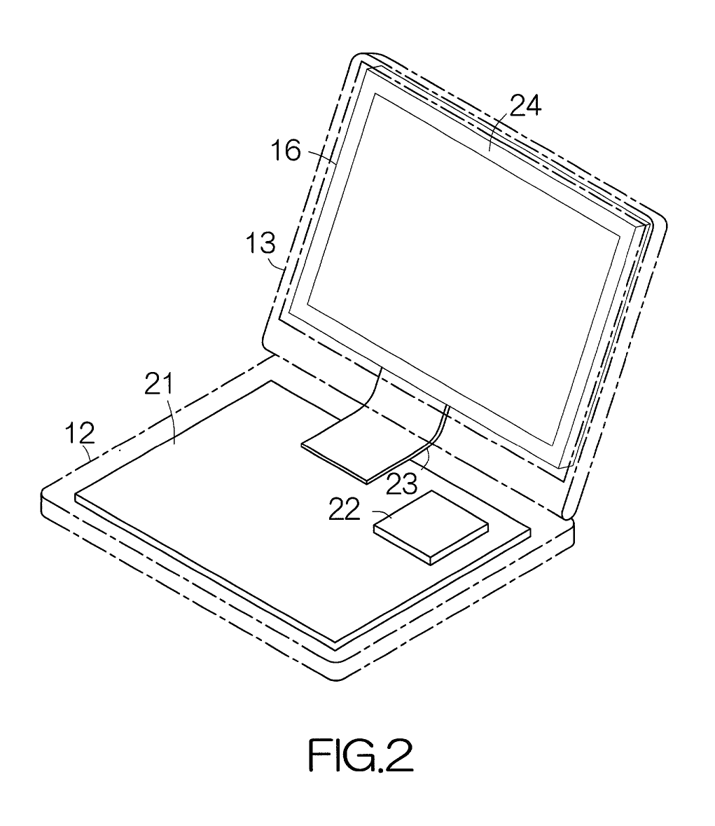

As shown in FIG. 2, a so-called motherboard 21 is incorporated within the main body 12 of the notebook personal computer 11. A CPU (Central Processing Unit) 22, for example, is mounted on the motherboard 21 in a conventional manner. The CPU 22 is designed to allow application programs to run on a predetermined operating software (OS), for example. The CPU 22 is allowed to utilize a random access memory (RAM) as well as a hard disk drive (HDD), both not shown, so as to execute the application programs. The operating speed or processing performance of the CPU 22 can be determined based on the frequency of a clock signal supplied to the CPU 22. In addition, the CPU 22 is designed to generate a driving signal for controlling the operation of the LCD panel module 16. A clock signal of a predetermined frequency can be utilized to generate the driving signal.

A flexible printed circuit board 23 extending from the LCD panel module 16 is connected to the motherboard 21. An electrically conductive pattern, not shown, is formed to extend over the surface of the flexible printed circuit board 23 for supplying the driving signal to the LCD panel module 16. Similarly, an electrically conductive ground pattern, not shown, is formed to extend over the surface of the flexible printed circuit board 23. This ground pattern is connected to a ground pattern on the motherboard 21.

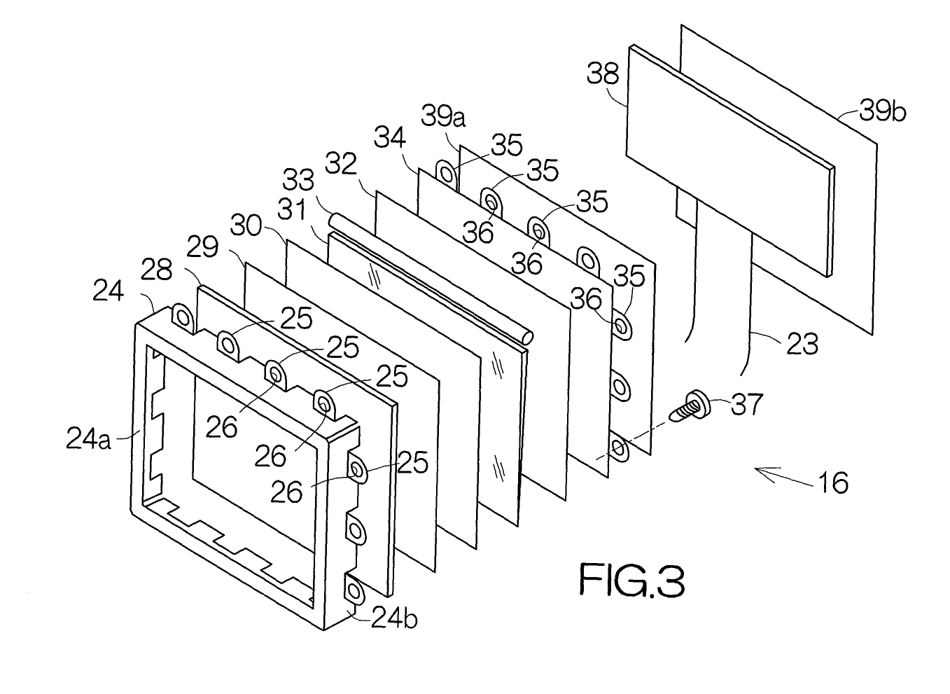

As shown in FIG. 3, the LCD panel module 16 of a first embodiment of the present invention includes an electrically conductive frame or bezel 24 surrounding the screen. The bezel 24 comprises a flat plate 24a extending along a plane, and a surrounding wall 24b standing from the outer periphery or edge of the flat plate 24a. The flat plate 24a is designed to define the rectangular window 17 for exposing the screen. The surrounding wall 24b is designed to enclose a flat rectangular parallelepiped space right behind the flat plate 24a. A plurality of coupling tabs 25 are integrally formed on the surrounding wall 24b at locations spaced by predetermined intervals as described later in detail. The coupling tabs 25 are designed to continuously rise outward from the outer surface of the surrounding wall 24b. Screw bores 26 are formed in the respective coupling tabs 25, for example. The bezel 24 of this type can be punched out of a stainless steel plate with a press, for example. The coupling tabs 25 can be obtained by folding portions of the punched-out stainless steel plate. The folding operation can be achieved at the same time when the bezel 24 is punched out of the stainless steel plate.

A rectangular LCD panel 28 is enclosed in the flat rectangular parallelepiped space defined within the bezel 24. The LCD panel 28 comprises liquid crystal cells sandwiched between a pair of glass substrates, for example. The individual liquid crystal cells correspond to the individual pixels of the screen. When the LCD panel 28 is set within the flat rectangular parallelepiped space, the outer periphery of the LCD panel 28 is enclosed in the surrounding wall 24b. The flat plate 24a of the bezel 24 is designed to receive the front surface of the LCD panel 28 around the screen.

Panel-shaped module components are located behind the LCD panel 28. The module components include a diffuser 29, a prism plate 30, a light pipe 31 and reflector 32, superposed on the back of the LCD panel 28 in this sequence. The module components 29-32 are designed to have rectangular shapes similar to that of the LCD panel 28. When the module components 29-32 are enclosed within the flat rectangular parallelepiped space, the outer peripheries of the respective module components 29-32 can be surrounded by the surrounding wall 24b of the bezel 24. A light source 33 is located adjacent the edge of the light pipe 31. The light pipe 31 and the light source 33 form a backlight unit. The light pipe 31 is designed to guide light from the light source 33 uniformly over the entire back surface of the LCD panel 28.

An electrically conductive member or sheet 34 is superposed on the back of the reflector 32. Electrically conductive tabs 35 are integrally formed on the electrically conductive sheet 34 so as to extend outward from the outer periphery of the rectangular electrically conductive sheet 34. The electrically conductive tabs 35 are arranged at locations spaced by the predetermined intervals in the aforementioned manner. Screw bores 36 are formed in the respective electrically conductive tabs 35, for example. When the electrically conductive sheet 34 is enclosed within the flat rectangular parallelepiped space, the individual electrically conductive tabs 35 are superposed on the corresponding coupling tabs 25. When electrically conductive or metallic screws 37 are received in the screw bores 36, 26 in sequence, the electrically conductive tabs 35 can be coupled with the coupling tabs 25. Electric joints can in this manner be established between the bezel 24 and the electrically conductive sheet 34. The electrically conductive sheet 34 is accordingly disposed behind the LCD panel 28.

A circuit board 38 is located behind the electrically conductive sheet 34 for controlling the display on the screen. The circuit board 38 is sandwiched between front and rear insulating sheets 39a, 39b. The front and rear insulating sheets 39a, 39b, along with the sandwiched circuit board 38, are then superposed on the back of the electrically conductive sheet 34. The insulating sheets 39a, 39b may have rectangular shapes similar to that of the LCD panel 28. When the insulating sheets 39a, 39b are enclosed within the flat rectangular parallelepiped space, the outer peripheries of the insulating sheets 39a, 39b are surrounded by the surrounding wall 24b of the bezel 24.

The aforementioned flexible printed circuit board 23 is coupled to the circuit board 38. The driving signal passing through the flexible printed circuit board 23 is supplied to a display controller established on the circuit board 38. The display controller controls the status of the individual liquid crystal cells on the basis of the supplied driving signal. The aforementioned electrically conductive ground pattern on the flexible printed circuit board 23 is connected to a ground pattern on the circuit board 38. The ground pattern on the circuit board 38 may be connected to a so-called frame ground established on the display housing 13 at several locations.

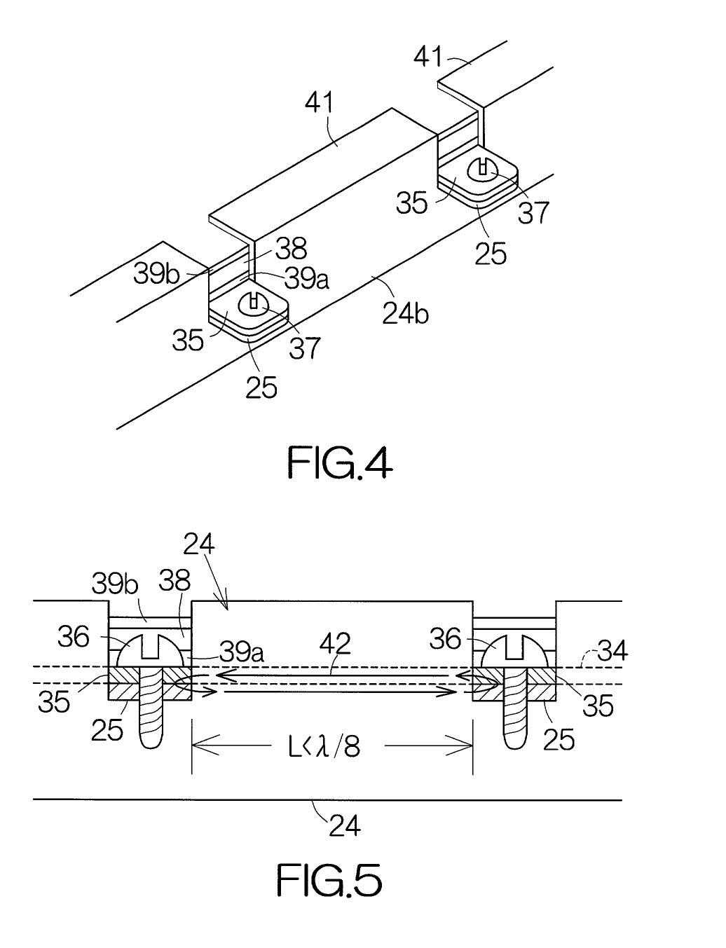

The bezel 24 serves to bind together the LCD panel 28, the module components 39-32, the electrically conductive sheet 34 and the insulating sheets 39a, 39b. In this case, folded portions 41 may be formed on the bezel 24, as shown in FIG. 4, for example. The folded portions 41 are designed to stand inward from the edge of the surrounding wall 24b of the bezel 24. The folded portions 41 may be located at positions between the adjacent coupling tabs 25, for example. The individual folded portions 41 serve to urge the LCD panel 28, the module components 29-32, the electrically conductive sheet 34 and the insulating sheets 39a, 39b against the back of the flat plate 24a of the bezel 24. The folded portions 41 can be cut out of the stainless steel plate when the bezel 24 is punched out of the stainless steel plate.

As shown in FIG. 5, the intervals L between the adjacent coupling tabs 25 as well as between the adjacent electrically conductive tabs 35 are set smaller than one eighth of the wavelength λ1 of the driving signal in the LCD panel module 16. The intervals L<λ1/8 enables establishment of loop lines 42 having the overall length smaller than the quarter of the wavelength λ₁ over the bezel 24 and the electrically conductive sheet 34. For example, when the driving signal is generated based on the clock signal of 166 MHz, having the wavelength k1 (=C/f) of approximately 1800 mm, the intervals L should be smaller than one eighth of the wavelength λ1, namely, smaller than approximately 225 mm. In this case, the length of the loop lines 42 can be set smaller than 450 mm, the quarter of the wavelength λ1.

In addition, when the intervals L between the adjacent coupling tabs 25 as well as between the adjacent electrically conductive tabs 35 is to be determined, one may consider not only the frequency of the driving signal supplied to the circuit board 38 but also any cyclic signal such as a clock signal supplied to the CPU 22 on the motherboard 21, a clock signal supplied to the memory or any other circuit elements on the motherboard 21, and the like. For example, if the notebook personal computer 11 utilizes a clock signal of 800 MHz, having the wavelength λ2 (=C/f) of approximately 375 mm, the intervals L should be smaller than one eighth of the wavelength λ2, namely, smaller than approximately 46.875 mm. In this case, the length of the loop lines 42 can be set smaller than 93.75 mm, the quarter of the wavelength λ2.

Next, a brief description will be made on the action of the notebook personal computer 11. The CPU 22 executes various processing in accordance with the OS and/or the application programs. The driving signal generated at the CPU 22 on the motherboard 21 is for example supplied to the LCD panel module 16 through the flexible printed circuit board 23. The display controller on the circuit board 38 serves to control the status of the individual liquid crystal cells in the LCD panel module 16. As a result, various text and/or graphics can be displayed on the screen of the LCD panel module 16.

The driving signal is supposed to cause an electromagnetic radiation from the circuit board 38. The electromagnetic wave is transmitted to the bezel 24, for example. The electrically conductive sheet 34 serves to diverge the electromagnetic wave out of the bezel 24. In this case, the loop lines 42 established over the bezel 24 and the electrically conductive sheet 34 serve to avoid generation of resonance between the electromagnetic wave and the bezel 24, since all the loop lines 42 are designed to have the length smaller than the quarter of the wavelength λ1 of the driving signal. The bezel 24 cannot function as a so-called loop antenna. The electromagnetic radiation can thus be reduced. In general, the electromagnetic radiation can remarkably be promoted in a loop antenna only if the loop antenna has the length equal to the half or quarter of the wavelength of the supplied signal. If the loop line 42 is designed to have the length smaller than the quarter of the wavelength λ1, the electromagnetic radiation can considerably be suppressed.

The clock signals for the CPU 22, the memory, and the other circuit elements are supposed to exert the influence on the electric current let off into the ground pattern on the motherboard 21. The clock signals may be transmitted to the circuit board 38 through the flexible printed circuit board 23. The clock signals are also supposed to cause an electromagnetic radiation from the circuit board 38. If the loop lines 42 established over the bezel 24 and the electrically conductive sheet 34 are designed to have the length smaller than the quarter of the wavelength λ2 in the above-described manner, the loop lines 42 serve to avoid generation of resonance between the electromagnetic wave and the bezel 24. The bezel 24 cannot function as a so-called loop antenna. The electromagnetic radiation can thus be suppressed. As conventionally known, the higher the frequency of a clock signal gets, the wavelength of the clock signal gets shorter. Accordingly, if the length of the loop line 42 is determined on the basis of the maximum frequency or minimum wavelength λ2 in the aforementioned manner, the length of the loop line 42 cannot at all coincide with the wavelength of any of the clock signals. It is possible to reliably suppress the electromagnetic radiation from the bezel 24.

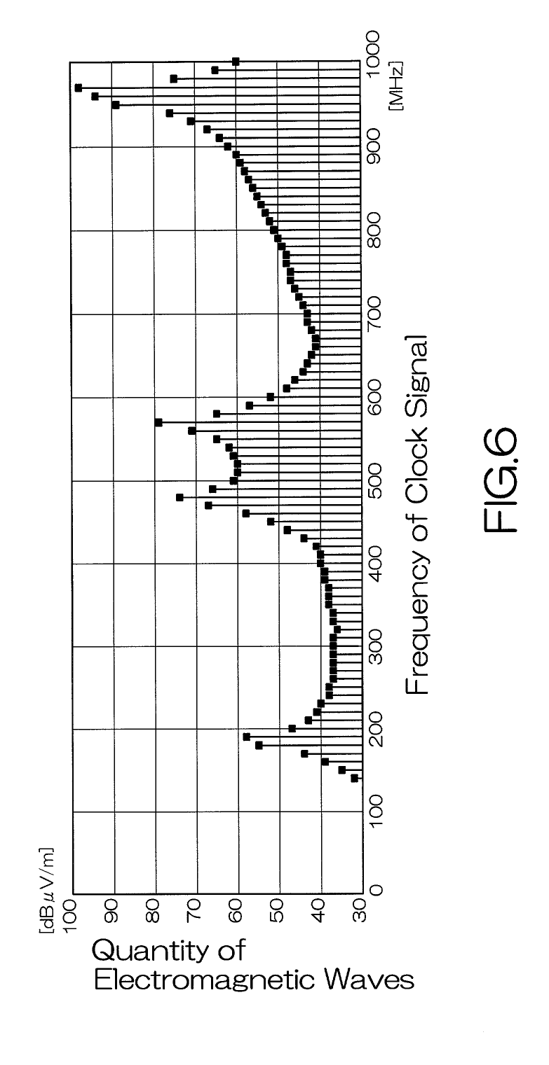

FIG. 6 illustrates the characteristic of the electromagnetic radiation from the LCD panel module 16. This characteristic was the result of an analysis based on a simulation software executed on a computer. The analysis was designed to reveal the quantity of the electromagnetic wave radiated from the LCD panel module 16. In the analysis, a clock signal was supplied to the circuit board 38 in the LCD panel module 16. The frequency of the clock signal was changed stepwise every 10 MHz, as is apparent from FIG. 6.

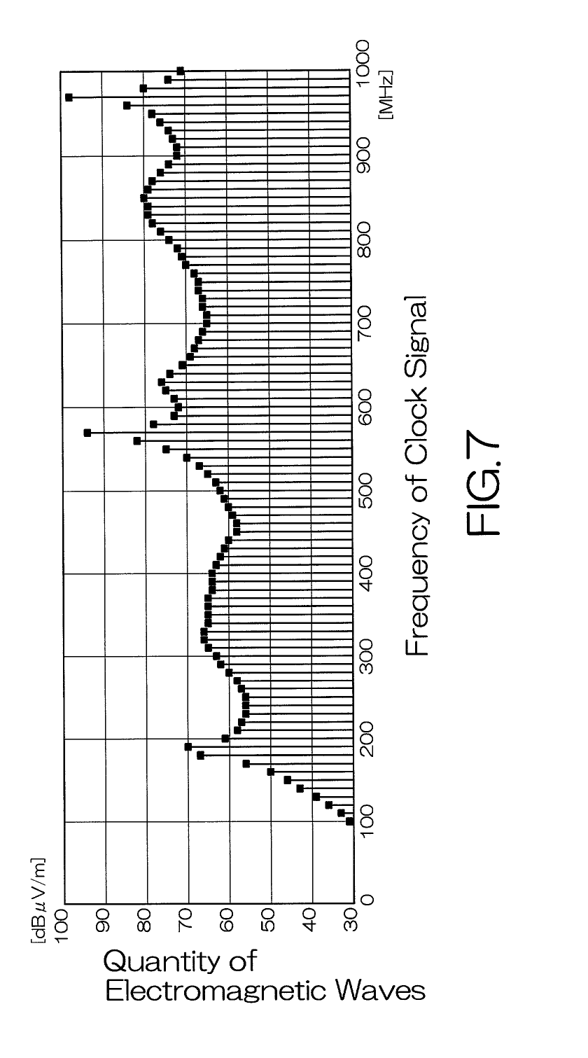

Similarly, FIG. 7 illustrates the characteristic of the electromagnetic radiation from an LCD panel module of a comparative example. No electric joints were established between the bezel 24 and the electrically conductive sheet 34 in this comparative LCD panel module. The comparative observation of FIGS. 6 and 7 demonstrates the reduction in the electromagnetic radiation in the frequency band between 200 MHz-450 MHz with the centered frequency of approximately 330 MHz (wavelength λ=0.9 m) as well as in the frequency band between 600 MHz-900 MHz with the centered frequency of approximately 660 MHz (wavelength λ=0. 45 m). It should be noted that the perimeter of the bezel 24 was set at approximately 0.9 m in this analysis.

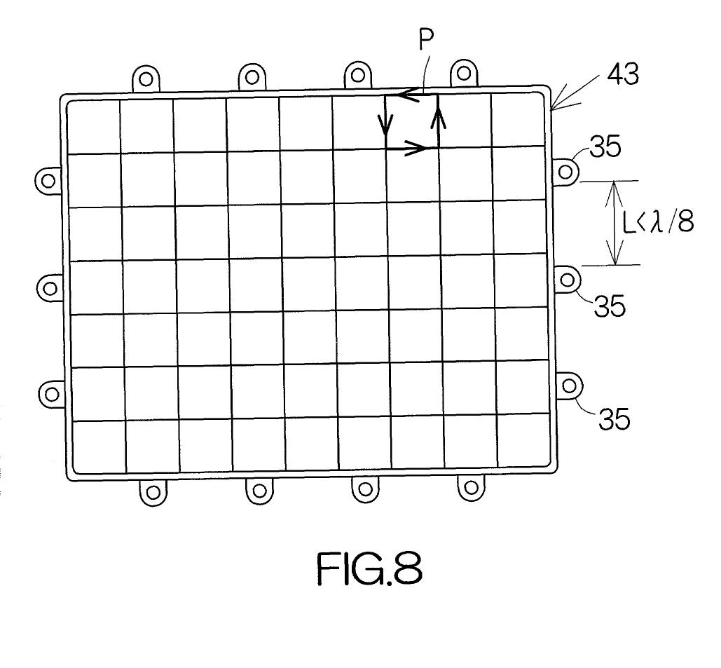

As shown in FIG. 8, for example, an electrically conductive meshed wire 43 can replace the aforementioned electrically conductive sheet 34 in the LCD panel module 16. Electrically conductive tabs 35 are integrally formed on the outer periphery of the meshed wire 43 at locations spaced by the predetermined intervals in the aforementioned manner. When the meshed wire 43 is coupled to the bezel 24, the relationship of L<λ1/8 can be established. Specifically, electric joints can be established between the meshed wire 43 and the bezel 24 at locations spaced by the intervals L smaller than one eighth of the wavelength λ1 of the driving signal, for example, in the same manner as described above. In addition, the perimeter P of the individual meshes of the meshed wire 43 is likewise set smaller than the quarter of the wavelength λ1 of the driving signal. The loop lines 42 established on the bezel 24 as well as the meshed wire 43 are always allowed to have the length smaller than the quarter of the wavelength λ1, so that the loop lines 42 serve to avoid generation of resonance between the electromagnetic wave and the bezel 24 as well as the meshed wire 43. The bezel 24 or the meshed wire 43 cannot function as a so-called loop antenna. The electromagnetic radiation can thus be suppressed.

As shown in FIG. 9, for example, any treatment for electric conductivity can be effected on the insulating back of the reflector 32 so as to establish the aforementioned loop lines 42. Such treatment may include plating, coating and vapor deposition of any electrically conductive material. The thus formed electrically conductive layer 44 can be employed to establish electric joints between the bezel 24 and itself at locations spaced by the intervals L smaller than one eighth of the wavelength λ1 of the driving signal, for example, in the aforementioned manner. The electrically conductive layer 44 serves to suppress the electromagnetic radiation in the manner described above.

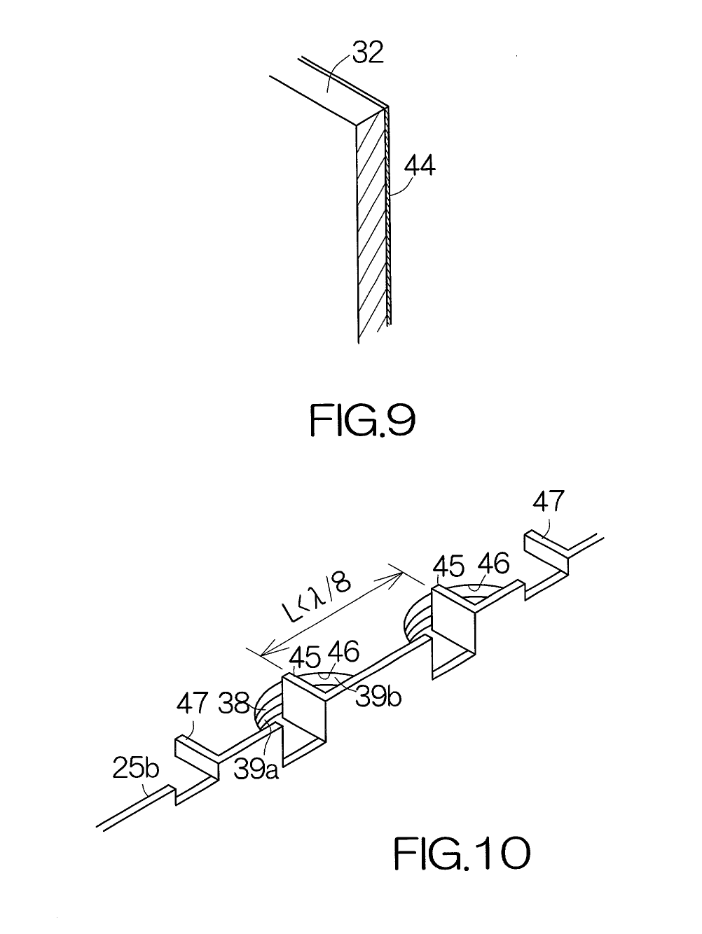

As shown in FIG. 10, for example, folded portions or pieces 45 may be employed to establish electric joints between the bezel 24 and the electrically conductive layer 44 in the LCD panel module 16. The folded piece 45 is a part of the stainless steel plate for the bezel 24 standing inward from the surrounding wall 24b of the bezel 24. The folded pieces 45 are arranged at locations spaced by the predetermined intervals L(<λ1/8) in the above-described manner. The folded pieces 45 are allowed to establish electric joints between the bezel 44 and the electrically conductive layer 44 without employment of the aforementioned coupling tabs 25 as well as the aforementioned electrically conductive tabs 35.

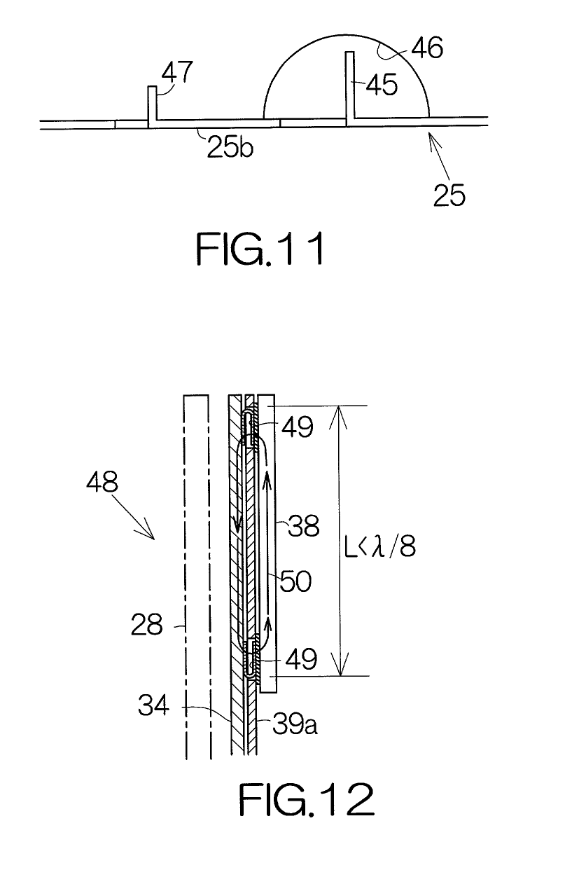

In this case, recesses 46 are preferably formed in the insulating sheets 39a, 39b and the circuit board 38, superposed on the surface of the electrically conductive layer 44 behind the reflector 32, so as to allow insertion of the folded pieces 45, as is apparent from FIG. 11. The recesses 46 serve to allow the insulating sheets 39a, 39b as well as the circuit board 38 to be superposed on the surface of the electrically conductive layer 44 without any interference to the folded pieces 45. Folded portions or pieces 47 likewise standing inward from the surrounding wall 24b of the bezel 24 may be employed to hold the insulating sheets 39a, 39b as well as the circuit board 38 within the bezel 24.

Otherwise, the electrically conductive sheet 34 and the insulating sheet 39a may be formed integral with each other. An insulating layer or coating may be formed on an aluminum foil, a copper foil, and the like, as the electrically conductive sheet 34.

FIG. 12 schematically illustrates a part of an LCD panel module 48 according to a second embodiment of the present invention. In this embodiment, electric joints are established between the electrically conductive sheet 34 and the ground pattern on the circuit board 38. Electrically conductive gaskets 49 are interposed between the electrically conductive sheet 34 and the circuit board 38 so as to establish the electric joints. The gaskets 49 are allowed to pass through openings or windows defined in the insulating sheet 39a, disposed between the electrically conductive sheet 34 and the circuit board 38. Like reference numerals are attached to the structures identical or equivalent to those of the aforementioned first embodiment.

The intervals L between the adjacent gaskets 49 should be set smaller than one eighth of the wavelength λ1 of the driving signal in the aforementioned manner. The establishment of L<λ1/8 always realizes establishment of the loop lines 50 having the length smaller than the quarter of the wavelength λ1 of the driving signal over the electrically conductive sheet 34 and the circuit board 38.

The gaskets 49 serve to transmit the driving signal as well as the clock signals from the ground pattern on the circuit board 38 to the electrically conductive sheet 34. The electrically conductive sheet 34 in cooperation with the gaskets 49 serves to diverge the driving signal and the clock signals running through the ground pattern on the circuit board 38. This divergence of the electric current enables a further reduction in the electromagnetic radiation from the LCD panel module 48. Moreover, since the loop lines 49 are designed to have the length smaller than the quarter of the wavelength λ1 of the driving signal, any loop antenna cannot be established in the LCD panel module 48 in the same manner as described above.

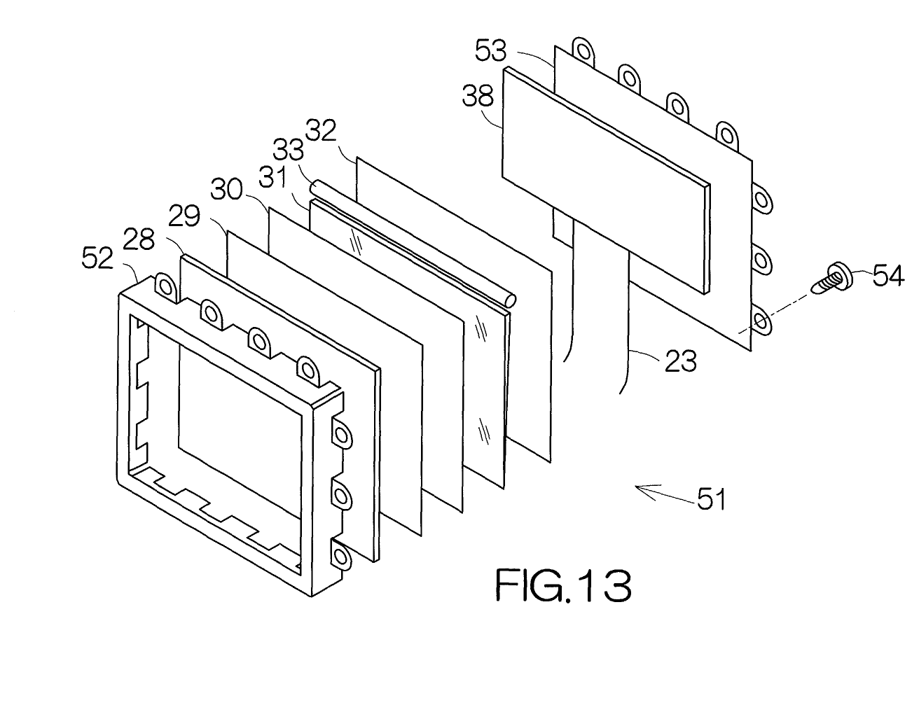

FIG. 13 schematically illustrates an LCD panel module 51 according to a third embodiment of the present invention. In this embodiment, a bezel 52 is made from an insulating material. The bezel 52 of this type can be molded out of any resin material. No electromagnetic wave is transmitted to the bezel 52 from the circuit board 38 and the ground pattern, so that the bezel 52 itself serves to avoid generation of resonance to the driving signal and any other clock signals. The bezel 52 should have the rigidity enough to prevent deformation of the LCD panel module 51 under the normal circumstance. Like reference numerals are attached to the structures identical or equivalent to those of the aforementioned first embodiment.

An insulating back cover 53 can be employed to bind the LCD panel 28, the prism plate 30, the light pipe 31 and the reflector 32 within the bezel 52, for example. Screws 54 may be employed to couple the back cover 53 with the bezel 52. The circuit board 38 may be sandwiched between the insulating layer at the back of the reflector 32 and the insulating back cover 53.

What is claimed is:

1. A display panel module comprising:
a display panel defining a screen on a front surface;
an electrically conductive frame enclosing the display panel; and
an electrically conductive member located behind the display panel and electrically connected to the electrically conductive frame.

2. The display panel module according to claim 1, wherein a loop line is established through the electrically conductive member and the electrically conductive frame, said loop line having a length different from a wavelength of a driving signal supplied to the display panel.

3. The display panel module according to claim 2, wherein said length of the loop line is set smaller than a half of the wavelength of the driving signal.

4. The display panel module according to claim 3, wherein electric joints are established between the electrically conductive member and the electrically conductive frame at positions spaced by intervals smaller than a quarter of the wavelength of the driving signal.

5. The display panel module according to claim 2, wherein said length of the loop line is set smaller than a quarter of the wavelength of the driving signal.

6. The display panel module according to claim 5, wherein electric joints are established between the electrically conductive member and the electrically conductive frame at positions spaced by intervals smaller than one eighth of the wavelength of the driving signal.

7. A display panel module comprising:
a display panel defining a screen on a front surface;
a panel-shaped module component superposed on a rear surface of the display panel; and
an electrically insulating frame enclosing the display panel and the panel-shaped module component so as to couple the module component to the display panel.

8. An electronic apparatus comprising:
a display panel defining a screen on a front surface;
a panel-shaped module component superposed on a rear surface of the display panel;
an electrically conductive frame enclosing the display panel and the panel-shaped module component so as to couple the module component to the display panel; and
an electrically conductive member located behind the display panel and electrically connected to the electrically conductive frame.

9. The electronic apparatus according to claim 8, wherein said display panel, said module component and said electrically conductive frame form a display panel module.

10. The electronic apparatus according to claim 9, wherein a loop line is established through the electrically conductive member and the electrically conductive frame, said loop line having a length different from a wavelength of a driving signal supplied to the display panel.

11. The electronic apparatus according to claim 10, wherein said length of the loop line is set smaller than a half of the wavelength of the driving signal.

12. The electronic apparatus according to claim 11, wherein electric joints are established between the electrically conductive member and the electrically conductive frame at positions spaced by intervals smaller than a quarter of the wavelength of the driving signal.

13. The electronic apparatus according to claim 10, wherein said length of the loop line is set smaller than a quarter of the wavelength of the driving signal.

14. The electronic apparatus according to claim 13, wherein electric joints are established between the electrically conductive member and the electrically conductive frame at positions spaced by intervals smaller than one eighth of the wavelength of the driving signal.
